(19) United States
(12) Patent Application Publication
(10) Pub. No.: US 2015/0367424 A1
(43) Pub. Date: Dec. 24, 2015

(54) Drilling Template, Drilling Template Arrangement And Method For Introducing Bores

(71) Applicant: Airbus Operations GmbH, Hamburg (DE)

(72) Inventors: Benjamin Obermeier, Hamburg (DE); Berta Gomez De Pedraza, Hamburg (DE); Sven Lutze, Hamburg (DE)

(73) Assignee: Airbus Operations GmbH, Hamburg (DE)

(21) Appl. No.: 14/741,586

(22) Filed: Jun. 17, 2015

(30) Foreign Application Priority Data
Jun. 18, 2014 (DE) 10 2014 211 689.9

(51) Int. Cl. B23B 49/02

(52) U.S. Cl. CPC B23B 49/02; B23B 2215/04; B23B 2270/12; B23B 2270/14; B23B 2270/16

(57) ABSTRACT

A drilling template for use in the field of producing aircraft or spacecraft or parts thereof has a first template part and a second template part. The first template part and the second template part are in each case provided here with means for fixing positions of bores to be produced. The drilling template has coupling means, by which the first template part and the second template part can be coupled to one another in such a way that the coupled template parts are movable relative to one another.

### FIELD OF THE INVENTION

The invention relates to a drilling template for use in the field of producing aircraft or spacecraft or parts of aircraft or spacecraft. Furthermore, the invention relates to a drilling template arrangement and to a method for introducing bores into components for an aircraft or spacecraft.

Even if the present invention is applicable in general to the introduction of bores into workpieces and, in particular, to the production of rivet holes, which are to be introduced into workpieces precisely and economically in a predetermined pattern, the invention and the problems on which it is based are to be described in more detail below using the example of producing a transverse seam on the connection between two fuselage sections of an aircraft fuselage.

### BACKGROUND OF THE INVENTION

It is known to assemble a fuselage of an aircraft from fuselage sections that are connected to one another. Adjacent fuselage sections can be connected to one another here in what is known as a transverse seam with the aid of rivet connections.

To produce rivet connections of this type, numerous rivet holes are to be introduced into the components to be connected, the fuselage sections in this example. The drilling of rivet holes and the production of the rivet connection itself is associated with a high expenditure of time and corresponding costs during the manufacturing of an aircraft, for example a passenger aircraft.

It may be important to find a way of further reducing the expenditure of time and costs when designing and producing an aircraft or spacecraft, in particular when producing transverse seam connections between mutually adjacent fuselage sections and simultaneously ensuring that the rivet holes are correctly positioned with respect to both components despite the production tolerances of the components to be connected.

### BRIEF SUMMARY OF THE INVENTION

One idea of the invention is therefore that of more quickly and economically allowing the correct introduction of bores into components, which are intended for an aircraft or spacecraft to be manufactured, preferably with still further improved quality of the bore configuration and bore positioning, wherein at the same time it is to be possible to take into account manufacturing tolerances of the components.

Accordingly, a drilling template for use in the field of producing aircraft or spacecraft or parts of aircraft or spacecraft is proposed, which has a first template part and a second template part. The first template part and the second template part are in each case provided here with means for fixing positions of bores to be produced. Furthermore, the drilling template has coupling means, by means of which the first template part and the second template part can be coupled to one another in such a way that the coupled template parts are movable relative to one another.

In addition, a drilling template arrangement having at least two drilling templates is proposed according to the invention, wherein at least a first of the drilling templates is configured in the above manner according to the invention and has a first template part and a second template part. In the drilling template arrangement according to an embodiment of the invention, a second drilling template engages over the first drilling template in regions.

The invention further provides a method for introducing bores into at least two components for an aircraft or spacecraft, which comprises the following steps:
providing at least one drilling template configured according to the invention having a first template part and a second template part; and
installing the drilling template to produce the bores with the aid of the drilling template, wherein manufacturing tolerances of one or both of the components are compensated by a movement of the first and second template parts relative to one another such that the positions of some of the bores to be produced can be aligned on one of the two components and the positions of other bores to be produced can be aligned on the other of the two components.

A concept on which the present invention is based consists in that the two template parts that are movable relative to one another can be aligned on two different workpieces, in particular two components for an aircraft or spacecraft, two adjacent fuselage sections by way of example. It thus becomes possible to correctly align defined bore positions relative to one of the components using the means of the first template part and to correctly align defined bore positions relative to the other component using the means of the second template part.

Thus, for example, when using a drilling template, as proposed by the invention, when connecting two fuselage sections in the region of a transverse seam of an aircraft fuselage, it can be ensured that rivet holes positioned and drilled by means of the first template part in relation to one of the fuselage sections, and rivet holes positioned and drilled by means of the second template part in relation to the adjacent other fuselage section do not unduly deviate from their respective desired position and, for example, maintain required edge spacings, even when the fuselage sections exhibit deviations from the desired dimension and/or desired geometry within the production tolerance.

The drilling template according to an embodiment of the invention and the method according to an aspect of the invention therefore allow the correct positioning of a large number of bores with a simultaneously rapid and economical introduction of said bores, and tolerance compensation, in particular for relatively large workpiece regions to be provided with bores. In the drilling template arrangement, further bores can additionally be positioned and drilled by means of the second drilling template without hindering the tolerance compensation by the relative mobility of the template parts of the first drilling template.

Reference is made in the present case to workpieces into which bores are to be introduced. It is obvious that the workpieces may be components for an aircraft or spacecraft. Components of this type may, in particular, be two adjacent fuselage sections for an aircraft fuselage.

Advantageous configurations and developments of the invention can be found in the description with reference to the figures.

According to one configuration, the coupled template parts are displaceable and/or rotatable relative to one another. This provides diverse possibilities for the compensation of manufacturing imprecisions

In one configuration, the first template part and the second template part are coupled to one another by means of the coupling means, in particular such that the drilling template having the first template part and the second template part can be transported as a whole in a non-installed state. In this manner, ergonomic advantages can be achieved and the transportation of the drilling template can be simplified for installation thereof or after uninstalling. The possibility of being able to transport the drilling template as a whole saves time and distances in comparison to transportation of the individual parts and makes handling easier for the worker.

In a further configuration, the first template part coupled to the second template part engages over at least one portion of the second template part in regions. An expedient coupling of the template parts can thus be achieved.

According to one configuration, the at least one portion of the second template part has at least one hole. Alternatively or in addition, the at least one portion in this configuration may be provided with at least one notch passing through the at least one portion in a thickness direction of the at least one portion. The hole and/or the notch advantageously allow access to the surface of a workpiece, for example a component for an aircraft, such as a fuselage section, in the region of the at least one portion of the second template part. As a result, it is, for example, possible, even in the region, in which the first template part engages over the second template part, to position and drill bores to be produced by means of the first template part when corresponding means are provided there in the first template part. Alternatively or in addition, it is possible to provide through-openings or notches to receive component or template fastening means in this region in the first template part.

In particular, the at least one portion of the second template part may have an arm or web, or a plurality of arms or webs, which, in the coupled state of the template parts, reach/reaches under the first template part. The web/arm and/or the webs/arms may, for example, delimit the hole or the holes and/or the notch or the notches. In particular, the web(s) or arm(s) may be configured between a plurality of holes, between a plurality of notches, or between a hole and a notch.

In one development, the first template part and the second template part are arranged, in an installed state of the drilling template having mutually coupled template parts, to rest, at least in regions, in each case, on a surface of at least one workpiece, into which bores to be produced are to be introduced using the drilling template. In particular, this can facilitate the measurement of the two template parts and provides defined contact of the template parts with respect to the workpiece or the workpieces.

In a further configuration, the means for fixing the positions of the bores to be produced are in each case configured with a through-opening or a notch, which extends through the template part which has the means. Means of this type may, for example, be advantageously suited to semi-automatic drilling methods such as a “concentric collet” method. In particular, the through-openings may be circular bores. The notches may be formed in that the bores are incorporated in an edge region of a template part in such a way that because of the overlapping of the edge with the bore, said bore is laterally open and thus forms a notch. The first template part and the second template part in each case preferably have a large number of through-openings or notches or both.

In one configuration, the coupling means comprise at least one slot, the slot being configured on one of the first and second template parts. Moreover, the coupling means in this configuration comprise at least one threaded hole, which is configured on the other of the first and second template parts. The slot and the threaded hole are configured in such a way here that for the coupling for the template parts, a screw can be guided through the slot and can be screwed into the threaded hole. A simple and reliable coupling of the template parts can thus be achieved. In addition, this type of coupling can make a temporary separation of the template parts possible if necessary, for example for repairs, exchange of a template part, cleaning and the like. The template parts can then be coupled again.

According to a development, the first template part and the second template part are in each case provided with at least one recess, which is configured to receive, in regions, a portion of a further drilling template in such a way that the portion of the further drilling template engages over the first and second template part, in each case in the region of the recess. For example, it can thus be achieved that the further drilling template, in a direction normal to the workpiece surface, does not project, or does not substantially project, over the first and second template part of the first drilling template, which, for example, can facilitate working with the drilling templates and the positioning and introduction of the bores to be produced with the aid of the drilling templates.

In one configuration, the at least one recess of the first template part and the at least one recess of the second template part are configured in such a way that the portion of the further drilling template can be received with clearance within the recesses in one direction or several directions. The clearance is preferably selected in such a way that the compensation of the expected manufacturing tolerances is not hindered. Therefore, the first and second template parts of the drilling template and the further drilling template can be installed at the same time on the workpiece or the workpieces, without having to dispense with the tolerance compensation by means of the two template parts that are movable in relation to one another.

In one configuration, the first template part and/or the second template part in each case have at least one hole or at least one notch. Alternatively, the first template part and/or the second template part may in each case be provided with at least one hole and with at least one notch. The hole or the notch or both penetrates/penetrate a base of the recess. In this manner, the portion of the further drilling template, which is received in the recesses, can advantageously also be provided with through-openings and/or notches, for example for means for positioning bores to be produced. The through-openings and/or notches may, however, alternatively be used, for example, to receive component fastening means or template fastening means. Access to the workpiece surface is made possible by the hole and/or the notch in the base of the recess.

In particular, regions of the respective template part adjoining the recess can be connected to one another by a web or by a plurality of webs. Each of the template parts may therefore be subdivided into a plurality of portions, which remain connected by the webs, which, in particular, simplifies handling.

According to a further configuration, the drilling template is configured for use when producing rivet holes for connecting two fuselage sections of a fuselage for an aircraft or spacecraft in the region of a transverse seam on the fuselage. Manufacturing tolerances, which appear when aligning the fuselage sections with one another, may be advantageously compensated in the region of the transverse seam by means of the drilling template. In view of the substantial number of rivet holes to be introduced, advantageous cost and working time savings can be achieved by using the drilling template.

In particular, it may be provided for the drilling template to be configured for installing the drilling template from an outside of the two fuselage sections onto the two fuselage sections or to be placed onto one of said fuselage sections.

According to a further development, the drilling template is configured as an orbital template or as a stringer template. In particular, the orbital template may be arranged to produce rivet holes along a joint region between the fuselage sections and in the region of a butt strap of one of the fuselage sections, which engages behind the adjacent fuselage section, while the stringer template may be arranged to produce rivet holes in the region of one or more stringer ends and/or a stringer coupling close to the transverse seam and/or thereover.

In an exemplary configuration, the template parts may be formed from a metal material, for example comprising aluminium or an aluminium alloy. A robust drilling template can thereby be achieved, for example.

In another configuration, the means for fixing the positions of the bores to be produced for the positioning and drilling of the bores are configured by means of a semi-automatic drilling method, in particular a concentric collet method. Semi-automatic drilling methods may, in comparison to manual methods, save costs and at the same time allow the quality of the bore configuration to be further improved.

In the case of a “concentric collet” method, a drilling device engages in a through-opening or notch, in particular a straight bore, in a drilling template, the drilling device, when the drilling process is triggered, being clamped in the through-opening or notch and carrying out the drilling process, optionally also a countersinking of the bore.

In alternative configurations, the means may, however, instead be arranged for use together with other drilling methods. For example, the means could have drill bushings.

In a development of the drilling template arrangement, the second drilling template is also configured in the manner according to the invention having a first and a second template part. The second drilling template thus advantageously also allows a tolerance compensation.

In a configuration of the drilling template arrangement one of the template parts of the second drilling template engages over the two template parts of the first drilling template in regions. With this configuration, for example, coupling means of the second drilling template can be displaced out of the region, in which the first drilling template is engaged over, which may simplify the construction of the drilling template arrangement.

In one configuration, it may be provided that the drilling template arrangement has a plurality of second drilling templates, which, in regions of the first drilling template provided therefor and spaced apart from one another, engage over the first drilling template. Thus yet more bores can be realised in a cost-saving and efficient manner with the aid of drilling templates.

According to one configuration, the drilling template arrangement is configured for use when producing rivet holes for connecting two fuselage sections of a fuselage for an aircraft or spacecraft in the region of a transverse seam on the fuselage. It is preferred here for the first drilling template to be configured as an orbital template and the second drilling template to be configured as a stringer template.

In one configuration of the method, at least one further drilling template is provided, the further drilling template being installed in such a way that the further drilling template engages over the drilling template in regions.

According to a further configuration of the method, the further drilling template is also configured in the manner according to the invention and also has a first template part and a second template part. For the tolerance compensation between the components, one of the template parts of one of the drilling templates and one of the template parts of the other drilling template are aligned on the one component. Furthermore, for the tolerance compensation, the other template part of one of the drilling templates and the other template part of the other of the drilling templates are aligned on the other component.

In another configuration of the method, the bores are introduced into the component or into the components by means of a semi-automatic drilling method, preferably by the concentric collet method.

In a further configuration of the method, a set of orbital templates and stringer templates provided to produce the connection in the region of the entire transverse seam is installed in one step. This allows further time and cost savings, as, in particular, repeated installation and uninstalling of templates can be avoided.

The configurations and developments described in relation to the drilling template may be applied to the drilling template arrangement and the method according to the invention. The advantages mentioned in relation to the drilling template apply accordingly to analogous configurations of the method and the drilling template arrangement.

If reasonable, the above configurations and developments can be combined with one another as desired. In addition, further possible developments, configurations and implementations of the invention also comprise combinations that are not expressly mentioned of features of the invention described above or below in relation to the embodiments. In particular, a person skilled in the art will also add individual aspects here as improvements or supplementations to the respective basic form of the invention.

### BRIEF DESCRIPTION OF THE DRAWINGS

The present invention will be described in more detail below with the aid of the embodiments disclosed in the schematic figures of the drawings, in which:

FIG. 1 is a side view of an exemplary aircraft, to illustrate the division of a fuselage thereof into fuselage sections;

FIG. 2 is a plan view of the aircraft of FIG. 1;

FIG. 3 is a plan view of a drilling template according to a first embodiment of the invention, which is installed for connecting two workpieces in an overlapping region thereof;

FIG. 4 is a perspective view from above of a drilling template arrangement having a first drilling template and three second drilling templates according to a second embodiment of the invention;

FIG. 5 shows a selection of parts of the drilling template arrangement of FIG. 4;

FIG. 6 shows a different selection of parts of the drilling template arrangement of FIG. 4;

FIG. 7 is a detail D1 from FIG. 5, shown enlarged;

FIG. 8 is a detail D2 from FIG. 4, shown enlarged;

FIG. 9 is a perspective bottom view of the first drilling template according to the second embodiment, viewed from the surface of a workpiece (not shown), having coupled first and second template parts;

FIG. 10 is a perspective view from above of the first drilling template from FIG. 9;

FIG. 10A shows a screw of a coupling means of the first drilling template of FIG. 9;

FIG. 11 is a perspective bottom view of the second template part of the first drilling template of FIG. 9, viewed from the surface of a workpiece (not shown);

FIG. 12 is a perspective plan view of the second template part of FIG. 11;

FIG. 13 is a perspective side view of the second template part of FIG. 11;

FIG. 14 is a perspective bottom view of the first template part of the first drilling template of FIG. 9, viewed from the side of a workpiece (not shown);

FIG. 14A is a partial view of the first template part of FIG. 14, viewed in perspective from the side AA;

FIG. 15 is a perspective bottom view of one of the second drilling templates according to the second embodiment from the side of a workpiece (not shown), having coupled first and second template parts;

FIG. 16 is a perspective plan view of the second drilling template of FIG. 15;

FIG. 16A shows a screw of a coupling means of the second drilling template of FIG. 15;

FIG. 16B is a perspective plan view of an end portion of the second template part of the second drilling template of FIG. 15;

FIG. 17 is a perspective side view from below of the first template part of the second drilling template of FIG. 15, from the surface of a workpiece (not shown);

FIG. 18 shows the drilling template arrangement according to the second embodiment, shown in a state in which the drilling templates are installed on the outside of two fuselage sections in the region of a transverse seam, but without fastening means or the like for fastening the drilling templates;

FIG. 19A is a perspective partial view of a drilling template according to a third embodiment of the invention;

FIG. 19B shows a template part of the drilling template according to FIG. 19A; and

FIG. 20 is a perspective part view of a drilling template according to a fourth embodiment of the invention.

The accompanying drawings are intended to convey a further understanding of the embodiments of the invention. They illustrate embodiments and are used in conjunction with the description to explain principles and concepts of the invention. Other embodiments and many of the advantages mentioned are clear with regard to the drawings.

The elements of the drawings are not necessarily shown true to scale in relation to one another. Elements, components and features that are the same, have the same functions and have the same effect—if nothing else is stated—are in each case provided with the same reference numerals in the figures of the drawings.

### DETAILED DESCRIPTION

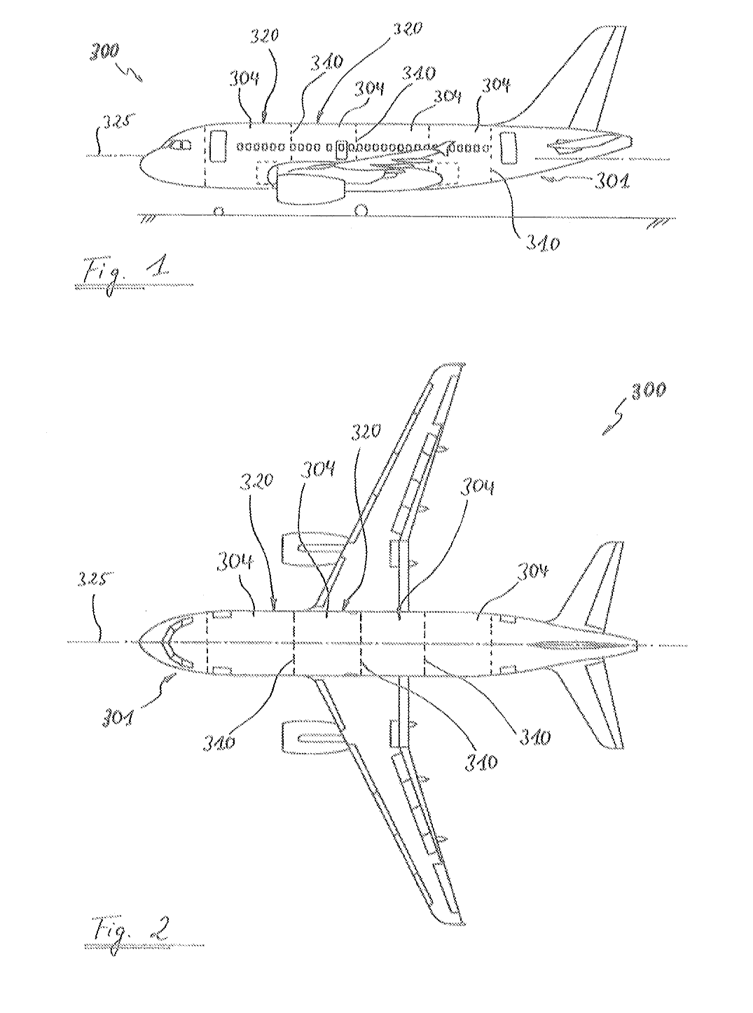

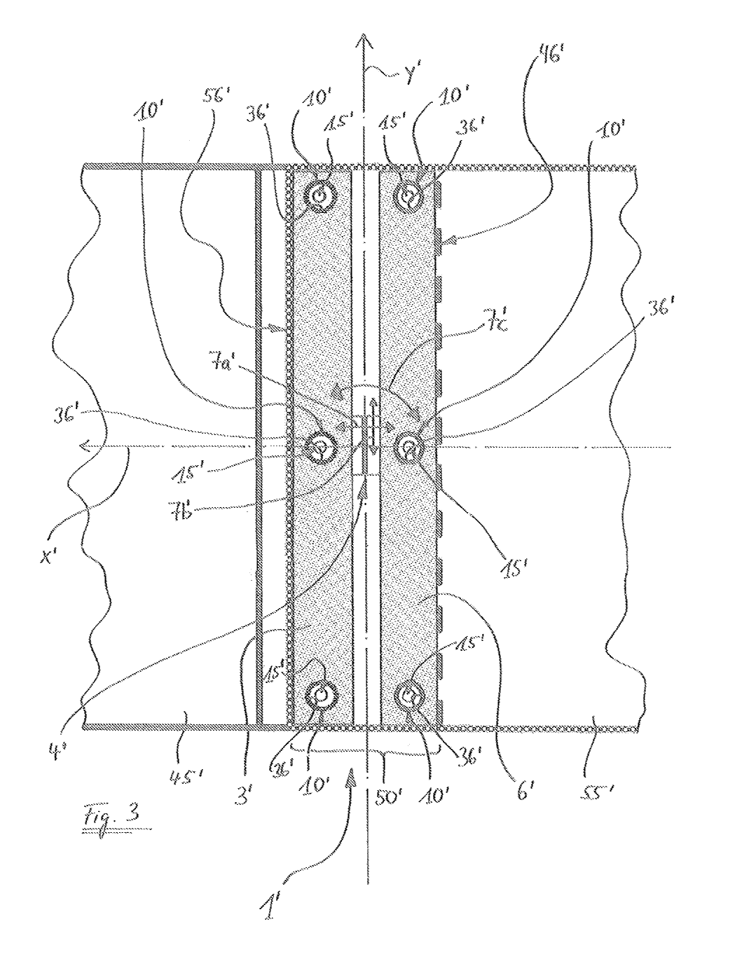

An aircraft configured as an aircraft 300, by way of example a modern passenger aircraft, is shown in FIGS. 1 and 2. The aircraft 300, in a manner known per se, has a fuselage 301 as well as aerofoils not denoted in more detail in the figures, a horizontal tail plane and rudder unit and engines. The fuselage 301 is formed by a plurality of fuselage sections 304, which are connected together along a longitudinal axis 325 of the aircraft 300, which longitudinal axis also forms a longitudinal axis of the fuselage 301, and are connected to one another in transverse seams 310. Some of the fuselage sections are denoted by 304 in FIGS. 1 and 2. External surfaces of the fuselage sections 304 are denoted by the reference numeral 320. The fuselage sections 304 indicated schematically by dashed lines in FIGS. 1 and 2 are, however, only to be understood by way of example. It is obvious that the fuselage 301 can be divided into fuselage sections in many other ways, for example into more or into fewer sections, which are shorter or longer than those shown in FIGS. 1 and 2.

FIG. 3 shows a drilling template 1′ according to a first embodiment of the invention, having a first template part 3′ and a second template part 6′, which are arranged in an overlapping region 50′ of two components 45′ and 55′ intended for an aircraft or spacecraft. One edge 46′ of the first component 45′ is covered in the viewing direction of FIG. 3 by the second component 55′ and therefore shown by dashed lines. The visible edge of the second component 55′ is denoted by the reference numeral 56′.

Each of the template parts 3′ and 6′ is provided in FIG. 3 with a plurality of means 10′, three in the example shown, for positioning bores 15′. With the aid of the drilling template 1′, the bores 15′ are to be drilled in the overlapping region 50′ through the first component 45′ and through the second component 55′ overlapping the first component 45′ in the overlapping region 50′ in regions. For this purpose, the means 10′ are preferably configured as through-openings 36′, in particular bores, through the respective template part 3′ or 6′. The diameters of the through-openings 36′ are preferably selected in such a way that the bores 15′ can be introduced in a semi-automatic drilling method, in particular by means of a drilling device having a “concentric collet”, into the components 45′, 55′.

In the drilling template 1′, the first template part 3′ and the second template part 4′ are coupled to one another with the aid of coupling means 4′ in such a way that the two template parts 3′ and 6′ can be moved relative to one another. The relative mobility is indicated in FIG. 3 by the arrows 7a′, 7b′, 7c′. In particular, the template parts 3′ and 6′ can be displaced relative to one another parallel to an external surface of the component 55′, on which the two template parts 3′, 6′ rest, and/or rotated in relation to one another about an axis substantially normal to this surface, i.e., in particular, one or two or all three of the mobilities 7a′, 7b′, 7c′ may be provided. The arrow 7b′ indicates a displaceability in a direction y′ substantially parallel to the edges 46′, 56′ and the arrow 7a′ indicates displaceability in a direction x′ normal to the direction y′.

The drilling template 1′ is used to define the drilling pattern to be realised and to be able to introduce the individual bores 15′ into the components 45′, 55′ in a rapid, precise and economical manner with high quality at the correct position.

In order to connect the two components 45′, 55′ to one another by means of a rivet connection, the components 45′, 55′ are aligned in relation to one another before the introduction of the bores 15′. Inevitable deviations of one or both of the components 45′, 55′ from their nominal dimensions within the permissible production tolerances may have an effect on the overlapping region 50′ and therefore the region of the drilling pattern. However, it may be required that individual bores 15′ introduced into the components 45′, 55′, and therefore also the rivet (not shown in the figure) guided through the rivet holes 15′ produced, do not exceed, in each case relative to at least one of the two components 45′, 55′, predetermined deviations from the nominal position relative to this component. In particular, it may be required, for example, that the bores 15′ do not fall below minimum spacings from the edges of the components 45′, 55′, for example from the edges 46′, 56′.

Using the drilling template 1′ it is possible to successfully maintain, for example, edge spacings of this type even when there are dimensional deviations of the components 45′, 55′. For this purpose, the two template parts 3′, 6′ are installed in such a way that they rest on the surface of the component 55′, the relative mobility of the template parts 3′, 6′ allowing the first template part 3′, together with those means 10′ said first template part comprises, to align on the edge 56′ of the second component 55′, while the second template part 6′ can be aligned on the edge 46′—concealed by the second component 55′ in FIG. 3—of the first component 45′. This relative movement therefore allows the compensation of dimensional and/or shape deviations of both components 45′, 55′ and the positioning of the means 10′ such that the bores 15′ produced with the aid of the drilling template 1′ in particular maintain the required edge spacings. The positions of the bores 15′ to be produced by means of the first template part 3′ are thus aligned on the second component 55′, and the positions of the bores 15′ to be produced by means of the second template part 6′ are aligned on the first component 45′.

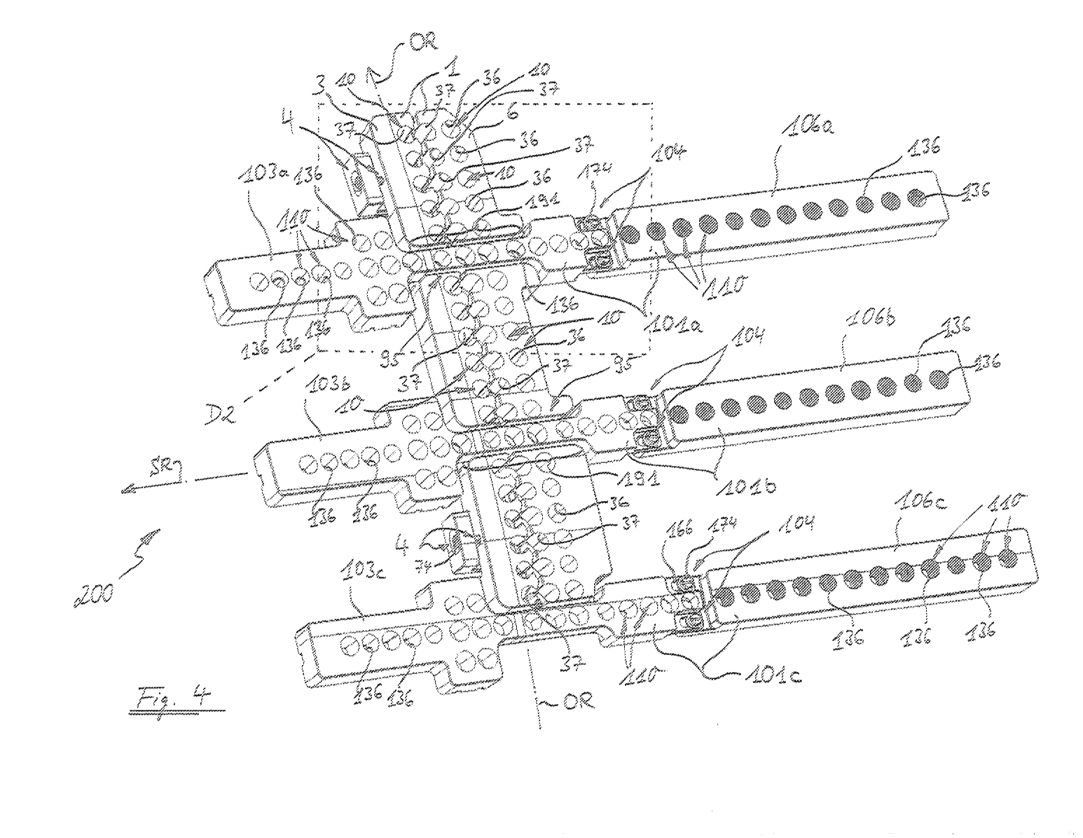

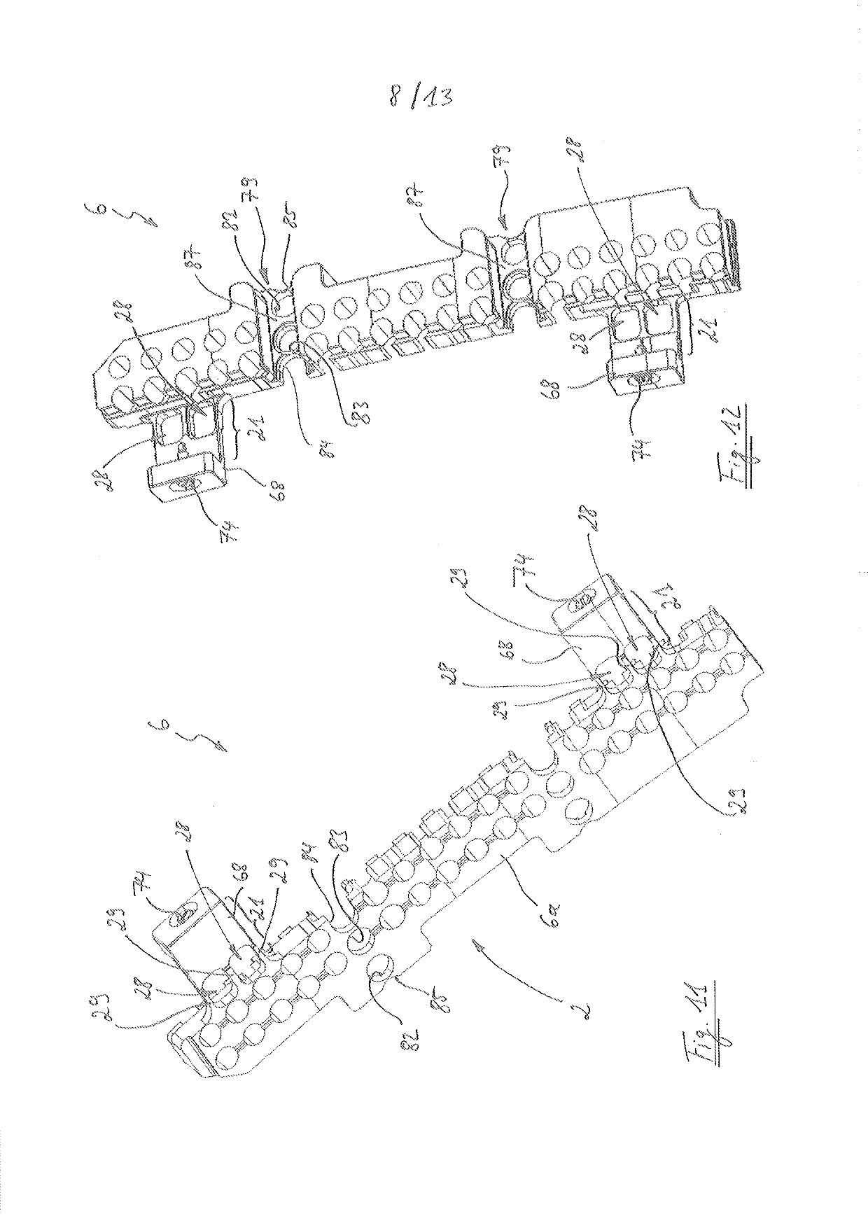

A second embodiment is to be described below with reference to FIGS. 4 to 18.

FIG. 4 shows a drilling template arrangement 200 according to the second embodiment of the invention, which has a first drilling template 1 and three second drilling templates 101a to c. The drilling template arrangement 200 is configured for use in the production of an aircraft fuselage and is used for the efficient, rapid and economic production of bores as rivet holes of high quality in the region of and close to a transverse seam 310 between two fuselage sections 304; see FIG. and 2. To produce an entire transverse or peripheral seam around the fuselage 301, a large number of drilling template arrangements 200 of the type shown in FIG. 4 can be used.

Firstly, the first drilling template 1 and the second drilling templates 101a to 101c are to be described.

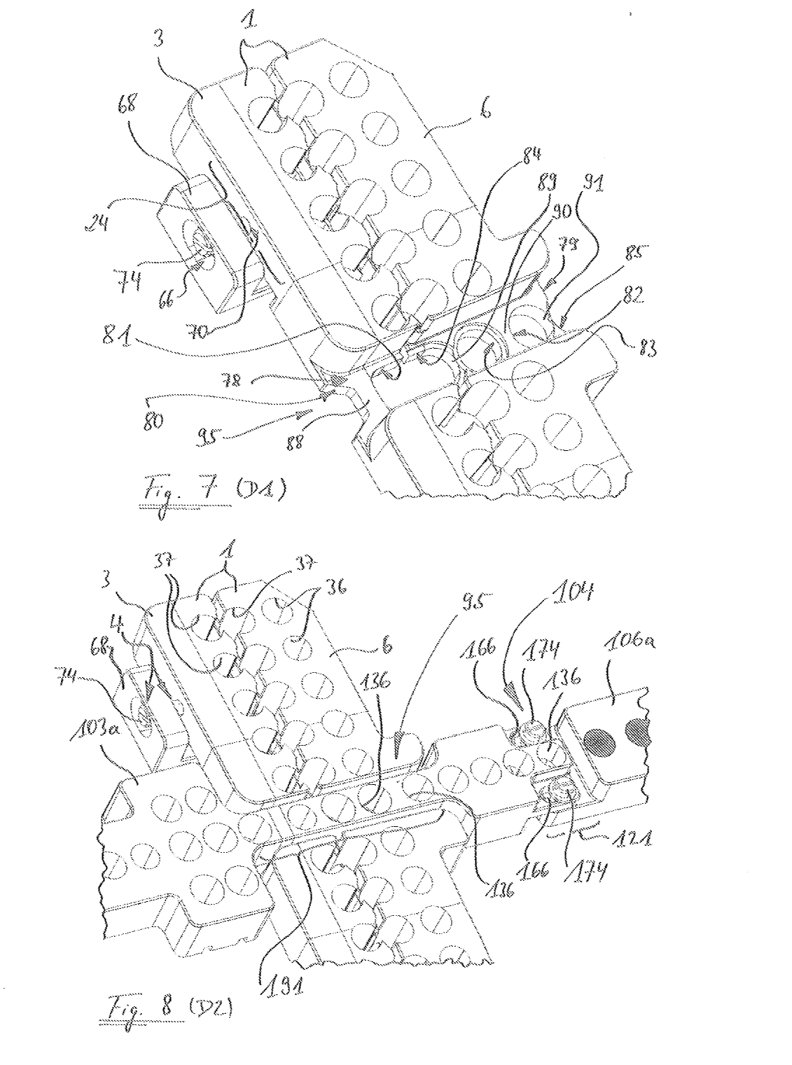

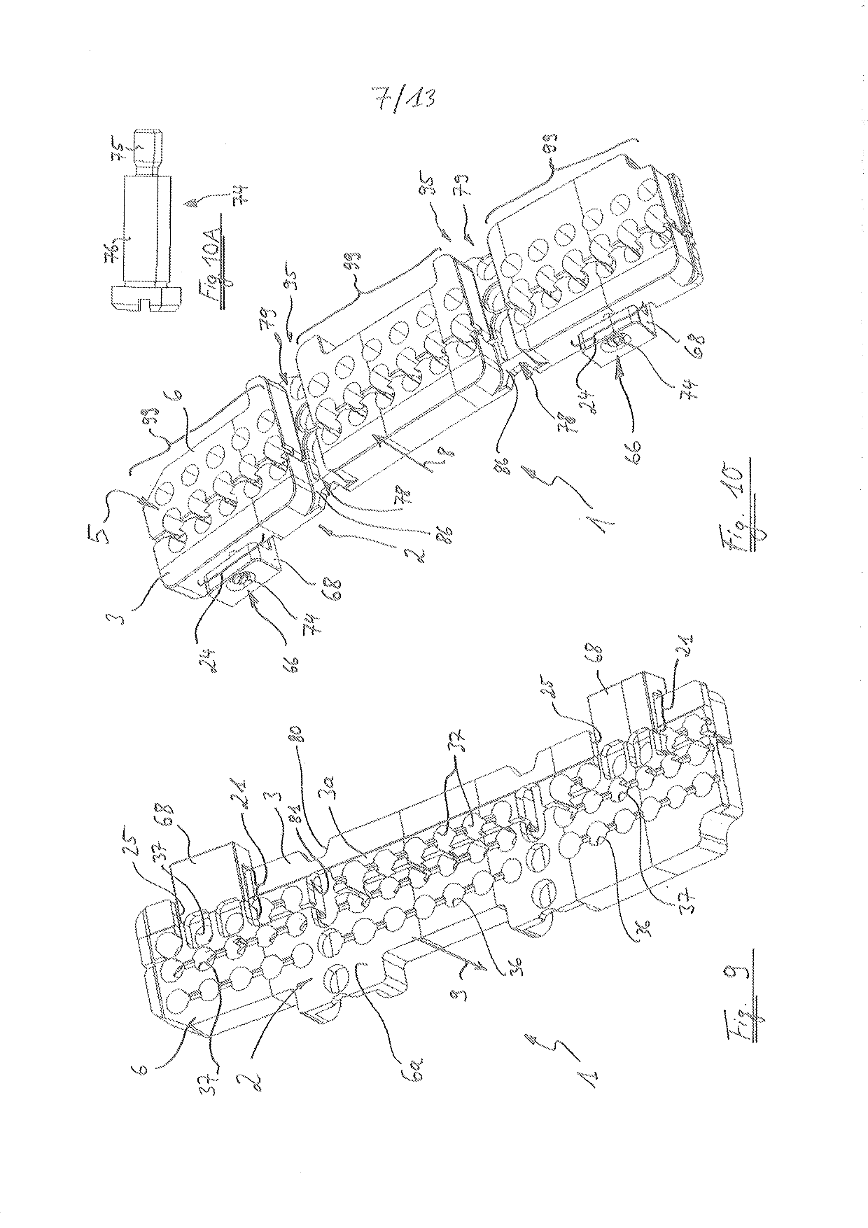

The first drilling template 1 has a first template part 3 and a second template part 6. The second template part 6 is configured with a large number of through-openings 36 configured as bores, the through-openings 36 extending in the thickness direction 9 (cf. FIG. 9) of the second template part 6 and through said second template part. For a better overview, for example in FIG. 4, only some of the through-openings 36 are provided with a reference numeral. Furthermore, the second template part 6 has notches 37, which also pass through the second template part 6 in the thickness direction 9, but are open towards the edge of the template part 6. Only some of the notches 37, too, are in each case provided with reference numerals in the figures. In the embodiment shown, the notches 37 are configured as bores passing through the second template part 6, the bores being laterally open because of their proximity to the edge thereof. The first template part 3 has a number of notches 37, which are configured, similarly to the second template part 6, as bores which pass through the first template part 3 and which are also open towards an edge facing the second template part 6. The details of the geometry can be seen from FIGS. 11 to 14.

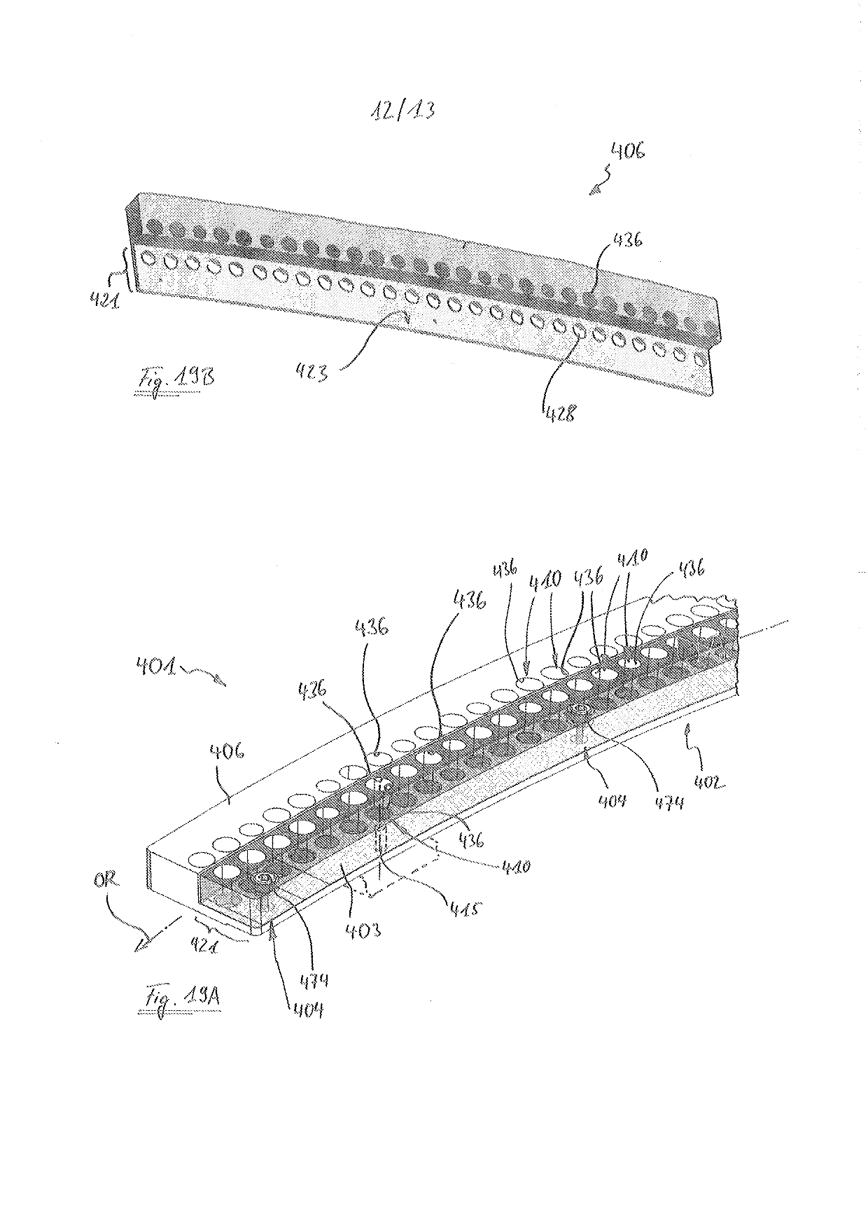

A large number of the provided through-openings 36 and notches 37 of both template parts 3, 6 in each case form a means 10 for fixing the positions of bores 15 to be produced, see FIG. 18, using a concentric collet drilling method, in which a drilling device is clamped in the respective through-opening 36 or notch 37 for positioning and to drill the bore 15. Some of the through-openings 36 and/or notches 37 may, in particular, be provided for the purpose of receiving component fastening means or template fastening means, while other through-openings 36 or notches 37 are in each case used as means 10 to be able to position and drill rivet holes. The diameters of the through-openings 36 and/or notches 37 may vary depending on their purpose.

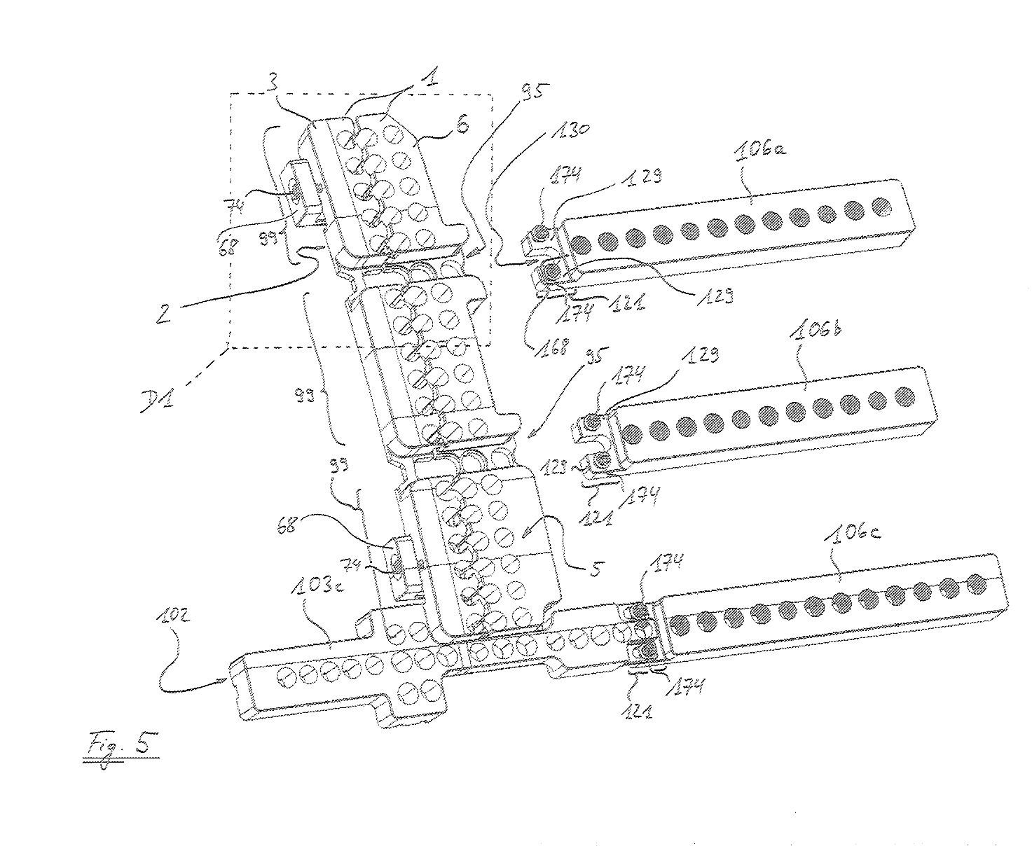

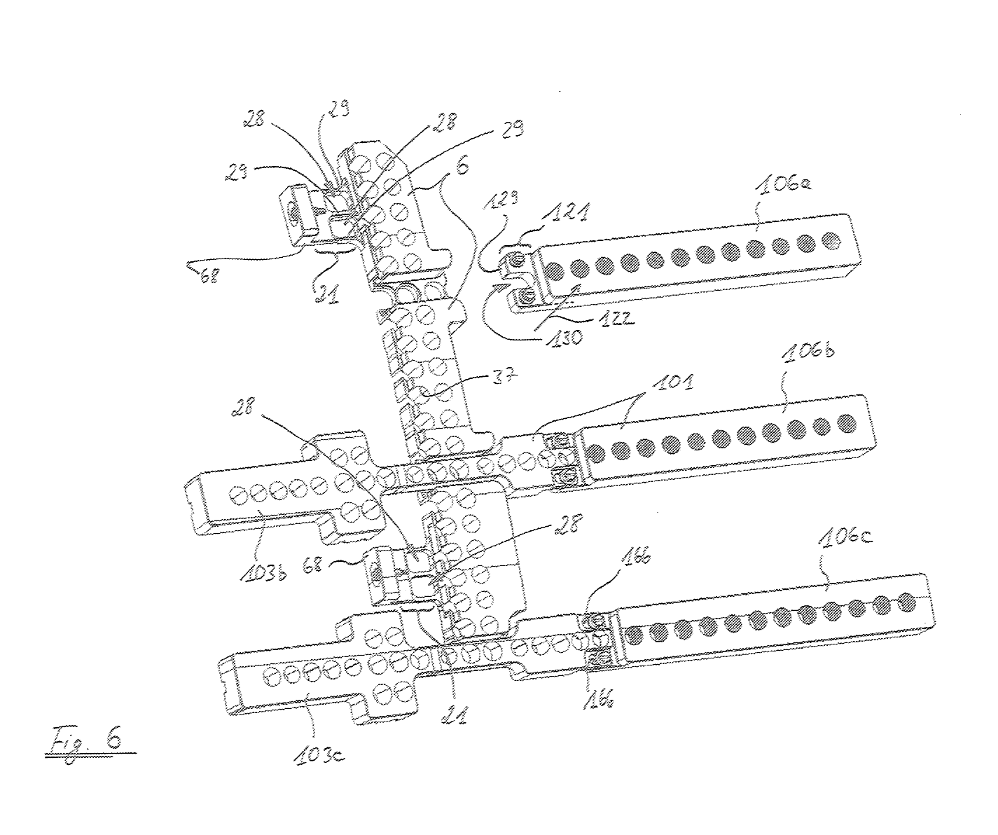

The drilling template 1 has coupling means 4 to movably couple the two template parts 3 and 6 to one another. The coupling means 4 comprise slots 66, threaded holes 70 and screws 74. The second template part 6 has projections 68 which are approximately L-shaped in cross section, see for example FIGS. 6 and 7, which engage under the template part 3 in portions. The slots 66 are in each case incorporated in one of the L-shaped projections 68; see, for example, FIG. 13. A threaded hole 70, which is formed on the first template part 3, is associated with each of the slots 66. The two template parts 3 and 6 are coupled to one another by means of a screw 74, which is shown separately in FIG. 10A, guided through the slot 66 and screwed into the threaded hole 70 with the threaded part 75 thereof, in such a way that they can move relative to one another. For this purpose, a shaft 76 of the screw 74 can move in the associated slot 66.

Owing to the coupling of the template parts 3 and 6, the drilling template 1 can be transported as a whole, for example in order to be able to install the drilling template 1 on adjacent fuselage sections 304 to be connected. The template parts 3 and 6 thus do not have to be carried separately by a worker to the workpiece, thus saving distances and time.

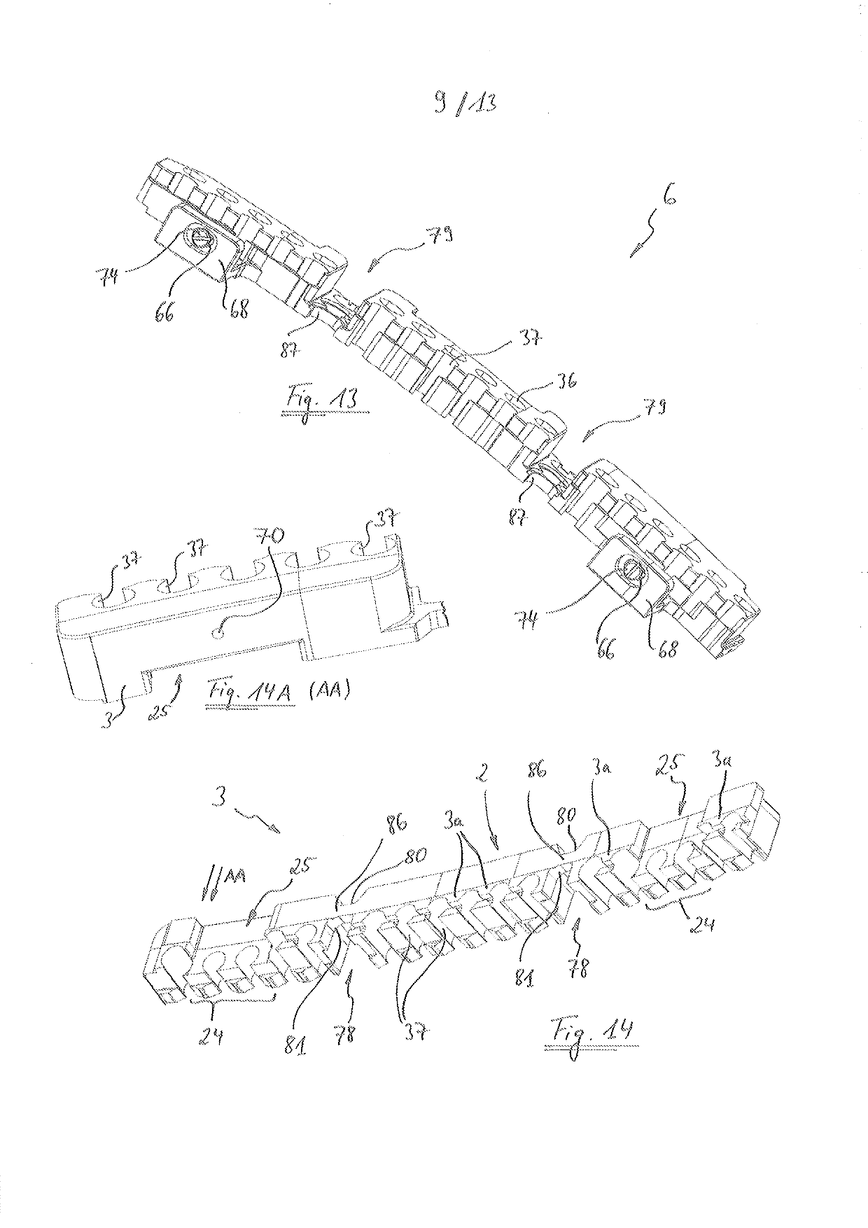

As can be seen in particular, from FIGS. 5, 7, 9 and 10, the first template part 3 in the coupled state of the two template parts 3, 6, engages over the second template part 6 in regions 24. For this purpose, the first template part 3 is equipped in the regions 24 with recesses 25, in which the portion 21 of the second template part 6 that has been engaged over in each case, can be received with clearance; see FIG. 14. The clearance is adequately large to allow the template parts 3 and 6 adequate mobility relative to one another both in an orbital direction OR of the fuselage section 304 in the region of the transverse seam and in an orientation direction SR of stringers for reinforcing a shell skin of the fuselage sections 304; see FIG. 18. The portion 21 forms a part of the projection 68. The portion 21 of the second template part 6 is provided with two continuous holes 28, see, for example, FIGS. 6, 11 and 12, webs 29, which delimit the holes 28 and extend below the first template part 3, remaining between the holes 28 and laterally with respect thereto.

Visible in FIGS. 9 and 11 is a side of the drilling template 1 facing the workpieces to be provided with the bores, for example adjacent fuselage sections 304, in the installed state of the drilling template 1. Both the first template part 3 and the second template part 6 are provided on the side 2 with contact faces 3a, 6a, with which the coupled template parts 3 and 6 can in each case rest on an external surface, for example one of the fuselage sections 304. As can be seen, for example, from FIG. 14 for the contact face 3a of the first template part 3, the contact face may be formed from a plurality of partial surfaces, separated by recesses 25 and notches 37.

The second drilling templates 101a, 101b and 101c, see FIG. 4, in each case have a first template part 103a, 103b, 103c and a second template part 106a, 106b, 106c. Each of the template parts 103a to c, 106a to c is provided with a large number of through-openings 136. The drilling templates 101a, 101b and 101c differ with respect to the number of through-openings 136 in the second template part 106b, on the one hand, and the second template parts 106a, 106c, on the other hand, and furthermore, the outer shaping of the first template part 103c differs in portions from that of the template parts 103a, 103b. However, the drilling templates 101a, 101b, 101c are moreover configured in substantially the same way. The configuration of the drilling template 101a will therefore be described in detail below in place of all the three drilling templates 101a to 101c, wherein the following descriptions are to apply accordingly to the drilling templates 101b and 101c.

The first and second template part 103a, 106a is in each case provided with a large number of through-openings 136, which are configured as bores. The through-openings 136 of the second template part 106a extend in the thickness direction 109 of the second template part 106a and therethrough, while the through-openings 136 of the first template part 103a extend in the thickness direction 108 of the first template part 103a and therethrough; see FIGS. 15 to 17.

In the drilling template 101a, a large number of the provided through-openings 136 of each of the two template parts 103a, 106a also form means 110 for positioning and drilling bores 115 to be produced, see FIG. 18, in a concentric collet drilling method. Some of the through-openings 136 may be provided for the purpose of receiving component fastening means or template fastening means.

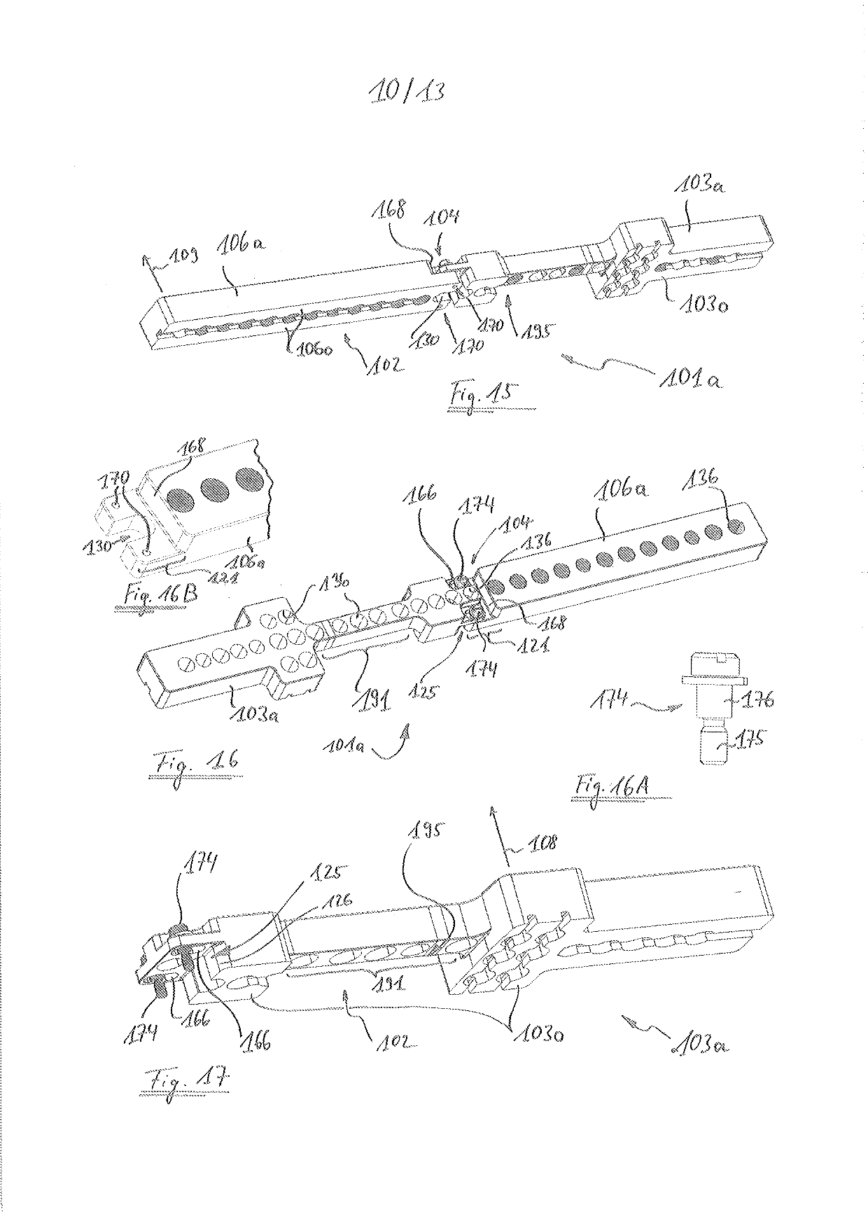

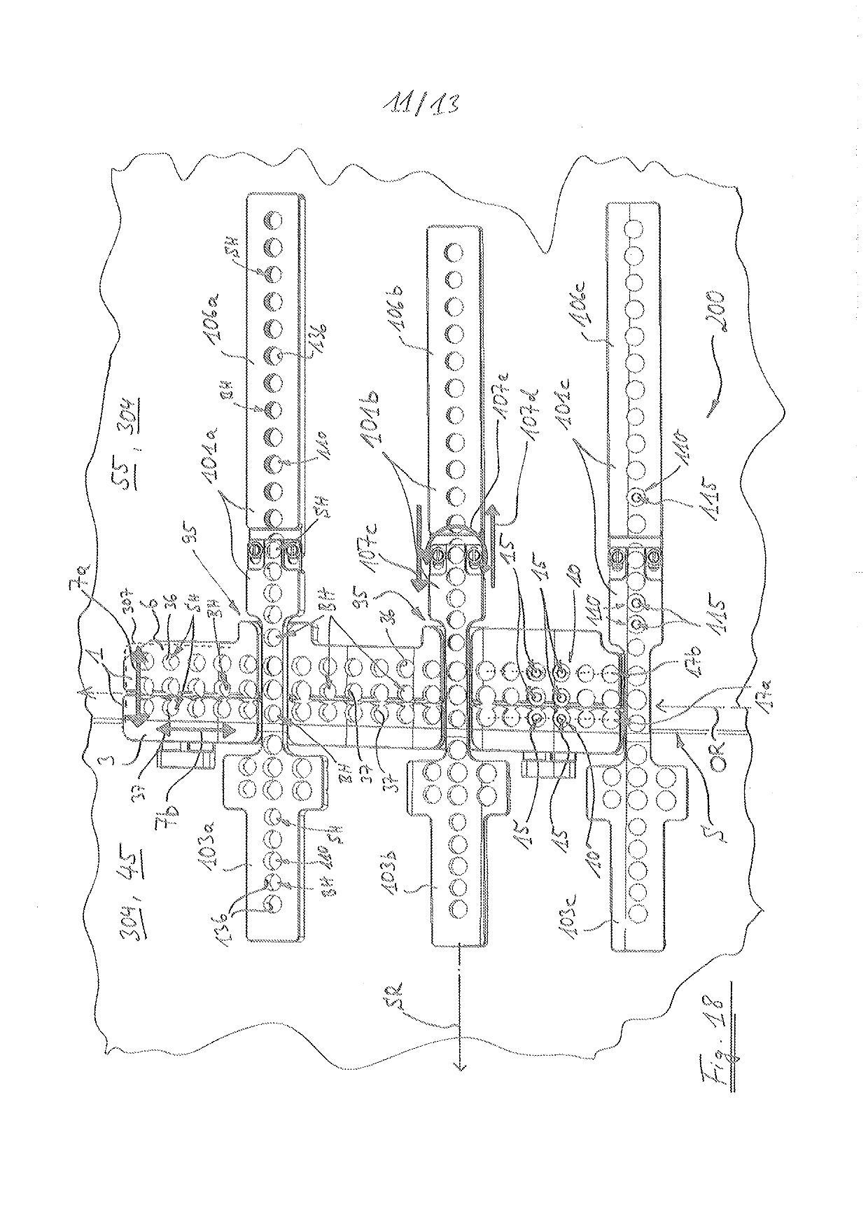

The drilling template 101a is equipped with coupling means 104, by means of which the two template parts 103a and 106a are coupled to one another so as to be movable relative to one another. In this case, the coupling means 104 comprise two slots 166 in an end region of the first template part 103a, threaded holes 170 in an end region of the second template part 106a facing the first template part 103a, and two screws 174, one of the screws 174 being shown separately in FIG. 16A. The screws 174 in each case extend with a shaft 176 through one of the slots 166 and are screwed by their threaded part 175 in one of the respective threaded holes 170. A relative mobility of the two template parts 103a, 106a with respect to one another is achieved by means of the mobility of the screws 174 in the slots 166 through which the screws 174 are guided.

The first template part 103a is provided in that end region, in which it has the slots 166, on a side 102 of the drilling template 101a, see FIGS. 15 and 17, facing the workpieces, for example the fuselage sections 304, in the installed state, with a recess 125, whereby the first template part 103a has a shoulder 126 in the end region. The end region of the second template part 106a equipped with threaded holes 170 has a shoulder 168. The first template part 103a can thus engage over a portion 121 of the second template part 106a in the region of the recess 125; see, for example, FIG. 16. The threaded holes 170 are arranged on the portion 121 on both sides of a notch 130, see FIGS. 5 and 16B, the notch 130 extending in a thickness direction 122 of the portion 121 and therethrough; see FIG. 6. The notch 130 is delimited on both sides by a respective arm 129, each arm 129 having one of the threaded holes 170 and extending below the first template part 103a.

Because of the coupling of the template parts 103a and 106a, the drilling template 101a—as well as each of the two other drilling templates 101b and 101c per se—is transportable as a whole. In order to be able to install the drilling template 101a on the fuselage sections 304 to be connected, in the case of the drilling template 101a, the template parts 103a, 106a do not have to be carried separately to the workpiece either, which in turn saves distances and working time.

The side 102 of the drilling template 101a facing the workpieces to be provided with the bores, for example adjacent fuselage sections 304, in the installed state of the drilling template 101a, can be seen in FIGS. 15 and 17. Both the first template part 103a and the second template part 106a are arranged so that the respective surfaces 103o or 106o thereof on the side 102 rest in each case on an external surface, for example of one or two adjacent fuselage sections 304. As can be seen, for example, from FIG. 17, for example the contact surface 103o may be formed from a plurality of partial surfaces, one of the partial surfaces of the surface 103o being able to rest on the external surface of one fuselage section 304 and the other partial surface being able to rest on the external surface of the fuselage section 304 that is adjacent in the transverse seam; cf. FIG. 18.

The template parts 3 and 6 of the first drilling template 1 and the template parts 103a to c and 106a to c of the second drilling templates 101a to c are preferably in each case manufactured from a metal material, for example from aluminium or a suitable aluminium alloy.

The structure and mode of functioning of the drilling template arrangement 200 having the drilling templates 1 and 101a to c are to be described in more detail with the aid of FIG. 18.

The drilling template arrangement 200 is used to produce bores 15, 115 as rivet holes in the region of a transverse seam 310 between two fuselage sections 304 of an aircraft; see FIG. 1, 2. The fuselage sections 304 form two components 45, 55 for an aircraft 300. Only some of the bores 15, 115 are drawn in FIG. 18 for a better overview. The drilling template 1 is referred to as an orbital template and extends with the main direction of extent thereof substantially in an orbital direction OR with respect to the fuselage 301. The drilling templates 101a to c, on the other hand, extend with their respective main direction of extent substantially in an orientation direction SR of stringers, not shown in the figures, by means of which a shell skin of the fuselage sections 304 is reinforced. The direction SR is only drawn by way of example for the drilling template 101b. The drilling templates 101a, 101b and 101c are referred to as stringer templates.

In the drilling template arrangement 200, as shown in FIG. 4, the second drilling templates 101a and 101b in each case, by way of example, engage over the first drilling template in the regions 95 thereof. For this purpose, the first template part 3 has recesses 78 in the regions 95 that are spaced apart from one another, while the second template part 6 has recesses 79, associated with the recesses 78, in the regions 95. The recesses 78 and 79 open toward a side 5 of the drilling template 1 remote from the workpieces, for example the surfaces of the adjacent fuselage sections 304. The recesses 78, 79, viewed in the orbital direction OR, are provided approximately at the same positions along the template parts 3, 6.

The engagement over the drilling template 1 is to be described using the example of the drilling template 101a. The drilling template 101a has an elongate portion 191, which forms a portion of the first template part 103a. In the region of the portion 191, the first template part 103a on the side 102 of the drilling template 101a facing the workpiece is provided with a recess 195, which opens towards the side 102; see FIG. 17.

The portion 191, the recesses 78, 79 and the recess 195 are dimensioned and arranged in such a way that the portion 191 can be received in the recesses 78, 79 with clearance and the first template part 103a therefore engages over the template parts 3 and 6 of the first drilling template 1, see, for example, FIG. 8, so the relative mobility of the template parts 3, 6 of the first drilling template 1 is not hindered.

The portion 191 is also provided with through-openings 136. In order to ensure access to a workpiece surface, on which the drilling template arrangement 200 is arranged, through the through-openings 136, a base 86 of the recess 78 is provided with notches 80 and 81, which penetrate the base 86 and between which a web 88 remains. Regions of the first template part 3 adjacent to the recess 78 of the first template part 3 are connected to one another by the web 88. Furthermore, a base 87 of the recess 79 is penetrated by two laterally open notches 84 and 85, and two round holes 82 and 83. Webs 89, 90 and 91 remain here, see FIG. 7, which connect regions of the second template part 6 adjacent to the recess 79 to one another.

As can be seen for example from FIGS. 5 and 10, the recesses 78, 79 in the regions 95 divide the drilling template 1 into a plurality of portions 99. By way of example, three portions 99 are shown for the second embodiment. However, it is obvious that the number of portions 99 may vary and the drilling template 1 may instead have, for example four or more portions 99, which are connected in a similar manner to the portions 99 in the second embodiment. However, the number of portions 99 and the dimensions of the drilling template 1 are preferably selected in such a way that the drilling template 1 having the two coupled template parts 3 and 6 can still be handled and transported as a whole by a worker in an ergonomic manner, in particular when considering the weight of the drilling template 1.

The use of the drilling template arrangement 200 for the precise, rapid and economical introduction of bores 15, 115 into components 45, 55 for an aircraft or spacecraft is schematically shown in FIG. 18. The components 45, 55 may be barrel-like fuselage sections 304 adjoining one another for an aircraft fuselage 301, on the external surface 320 of which the drilling template arrangement 200 is placed and installed to produce rivet holes in the region of a transverse seam 310. In FIG. 18, a joint region between mutually adjacent fuselage sections 304 on the outside of the fuselage 301 is denoted by the reference numeral S. In this case, the component 45 may extend, for example with a butt strap 307 indicated only very schematically and in portions in FIG. 18, under the component 55.

All the drilling templates 1, 101a to c may be installed simultaneously on the components 45, 55. For a complete transverse seam 310 around the periphery of the aircraft fuselage 301, an entire set of orbital templates and stringer templates, i.e. a large number of drilling template arrangements similar to the drilling template arrangement 200, can therefore be installed on the outside of the adjacent fuselage sections 304 to be connected. A compensation of deviations of the components 45, 55 from their respective nominal dimensions within the production tolerances takes place here with the aid of the relative mobility of the template parts 3, 6 as well as the relative mobility of the template parts 103a to c, 106a to c.

The movement possibilities of the template parts are indicated by arrows in FIG. 18. For example, the template parts 3 and 6 can be displaced relative to one another in accordance with the arrows 7b, 7a in the orbital direction OR and transverse thereto. The extent of the displaceability can be adapted by suitable dimensioning of the template parts 3, 6, in particular their coupling means 4 and recesses 25, 78, 79, to the required tolerance compensation possibilities.

The drilling template arrangement 200 having the drilling templates 1, 101a to c thus makes it possible, for example, with compensation of production imprecisions, to align a row 17a of rivet holes to be produced, which row is defined by the first template part 3, on the second component 55 in order to maintain, in particular, required minimum edge spacings in relation to this component 55. At the same time, another row 17b, defined by the template part 6, of bores 15 for rivet holes can be aligned on the first component 45 in order, for example, to maintain minimum edge spacings of the rivet holes of the row 17b in relation to the butt strap 307 of the component 45, which engages under the component 55. The relative mobility of the template parts 3, 6 therefore allows a correct positioning of the bores 15 in relation to the two components 45, 55, while at the same time, to compensate production imprecisions, an alignment of the components 45, 55 by moving one in relation to the other—for example a rotation of one of the fuselage sections 304 in relation to the adjacent one—remains possible.

In a similar manner, the second drilling templates 101a to c, owing to the relative mobility of the template parts 103a to c, 106a to c, allow the correct positioning of bores 115 as rivet holes for a reinforcement structure, in particular stringers and stringer couplings, in the region of the transverse seam 310. The relative movements of the template parts 103a to c, 106a to c may be displacements 107c, 107d in the orientation direction SR of the stringer and/or a mutual pivoting 107e.

Thus, for tolerance compensation, the second template part 6 of the first drilling template 1 and the first template parts 103a to c of the second drilling templates 101a to c can be aligned on the first component 45, while the first template part 3 of the first drilling template 1 and the second template parts 106a to c of the second drilling templates 101a to c can be aligned on the second component 55.

The means 10, 110 for positioning and drilling bores 15, 115 are configured in the semi-automatic concentric collet method in the case of the drilling templates 1, 101a to c. Some of the through-openings 36, 136 and notches 37 of the drilling templates are configured, as indicated by way of example in FIG. 18, for the use of template fastening means—indicated schematically by the reference numeral SH—or to receive component fastening means—indicated schematically by the reference numeral BH.

Access to the workpiece surface through the through-openings 136 in the portion 191 of the first template parts 103a to b is made possible with the aid of holes 82, 83 and notches 80, 81, 84, 85, which are dimensioned to be adequately large for access of this type to still be possible even once a relative movement has taken place of the template parts 3, 6 and taking into account the clearance of the portion 191 in the recesses 78, 79. Moreover, access to the workpiece surface, in the example the external surface of the component 55, through the notches 37 in the first template part 3 of the drilling template 1 is made possible by the holes 28, which are also adequately dimensioned to still allow access even with a relative movement of the template parts 3, 6. In a similar manner, the notches 130 allow access to the surface of the component 55 through the respective last through-opening 136 in the template part 103a to c, the recess 130 also being designed such that with a relative movement of the template parts of the templates 101a to c, access still remains possible.

The precise introduction of the bores 15, 115 can therefore take place more rapidly and economically by means of the drilling templates 1, 101a to c. In addition, the orbital and stringer templates for the entire transverse seam 310 can be installed in a time-saving manner in one step on the adjacent fuselage sections 304. Furthermore, advantages are achieved from an ergonomic point of view as each of the drilling templates 1, 101a to c, although formed having two pieces that are movable in relation to one another, can be transported as a whole per se due to the coupled arrangement. This saves the worker time and distances, which he would otherwise need for carrying individual template parts back and forth separately, for example when climbing stairs.

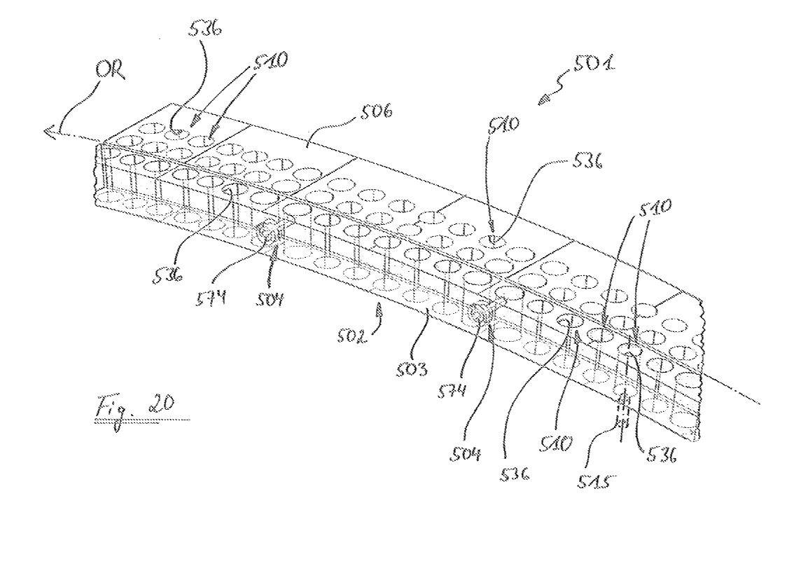

FIG. 19A shows a drilling template 401 according to a third embodiment of the invention, which has a first template part 403 and a second template part 406. The template parts 403 and 406 are shown coupled to one another in FIG. 19A. Each of the template parts 403, 406 has through-openings 436 configured as bores, of which at least several, in each case, form means 410 for positioning bores 415. The first template part 403 rests displaceably on a surface 423 of a portion 421 of the second template part 406, the portion 421 being formed in the region of a recess extending in the longitudinal direction of the template part 406; see FIG. 19B. OR also denotes an orbital direction in FIG. 19A in the region of a transverse seam 310 between two fuselage sections 304 and the longitudinal direction of the template part 406 extends in the orbital direction OR. Coupling means 404 comprise screws 474, with the aid of which the first template part 403 is coupled to the second template part 406 such that the template parts 403, 406 can be moved relative to one another. In particular, the first template part 403 is displaceable relative to the second template part 406 in and transverse to the orbital direction OR. In order to allow access to a workpiece surface, not shown, through the through-openings 436 of the first template part 403, the portion 421 is provided with holes 428. The side facing the workpiece is denoted by the reference numeral 402. In the coupled state, the cross section of the drilling template 401 extending in the orbital direction OR, apart from the bores 436, is substantially rectangular and substantially constant in the orbital direction OR.

A drilling template 501 according to a fourth embodiment, which also has a first template part 503 and a second template part 506, which are both provided in each case with through-openings 536, which are configured as bores, is shown in FIG. 20. At least some of the through-openings 536 of each of the template parts 503, 506 in each case in turn form means 510 for positioning bores 515 to be produced in a workpiece. The template parts 503, 506, apart from the through-openings 536, have a substantially rectangular cross section in each case and can rest next to one another on a surface of a workpiece. The drilling template 501, in the installed state, turns the side 502 to the workpiece. The template parts 503, 506 that are movably coupled relative to one another by the coupling means 504 comprising screws 574, can be displaced, in particular, in the orbital direction OR and transverse thereto in relation to one another.

In particular when the drilling template is configured as an orbital template, as is the case in the drilling templates 1, 401 and 501, to produce a transverse seam 310 on an aircraft fuselage 301, the drilling template is curved in the direction of longitudinal extent thereof, parallel to the orbital direction OR, in accordance with the cross section of the fuselage 301 in the region of the transverse seam 310.

Although the present invention has been completely described above with the aid of preferred embodiments, it is not limited thereto, but may be modified in a diverse manner.

In particular, the invention is not limited to the production of rivet holes for transverse seams on the aircraft fuselage but may be applied to the production of bores in many kinds of components of an aircraft or spacecraft in a useful manner.

It is also pointed out that “a” does not rule out a plural in the present case.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A drilling template for use in the field of producing aircraft or spacecraft or of parts thereof, comprising:
a first template part; and
a second template part′
wherein the first template part and the second template part are in each case provided with means for fixing positions of bores to be produced, and
wherein the drilling template has coupling means, by which the first template part and the second template part can be coupled to one another in such a way that the coupled template parts are movable relative to one another.

2. The drilling template according to claim 1, wherein the first template part and the second template part are coupled to one another by the coupling means.

3. The drilling template according to claim 1, wherein the first template part coupled to the second template part engages over at least one portion of the second template part in regions.

4. The drilling template according to claim 3, wherein the at least one portion of the second template part has at least one of at least one hole and at least one notch passing through the at least one portion in a thickness direction of the at least one portion.

5. The drilling template according to claim 1, wherein the first template part and the second template part are arranged, in an installed state of the drilling template having mutually coupled template parts, to rest, at least in regions, in each case, on a surface of at least one workpiece, in which bores to be produced are to be introduced using the drilling template.

6. The drilling template according to claim 1, wherein the means for fixing the positions of the bores are in each case configured with a through opening or a notch, which extends through the template part which has the means.

7. The drilling template according to claim 1, wherein the coupling means comprise at least one slot configured on one of the first and second template parts, and at least one threaded hole configured on the other of the first and second template parts, the slot and the threaded hole being configured in such a way that for coupling the template parts, a screw can be guided through the slot and can be screwed into the threaded hole.

8. The drilling template according to claim 1, wherein the first template part and the second template part are in each case provided with at least one recess configured to receive, in regions, a portion of a further drilling template such that the portion of the further drilling template engages over the first and second template part, in each case, in the region of the recess.

9. The drilling template according to claim 8, wherein at least one of the first template part and the second template part in each case have at least one of at least one hole and at least one notch penetrating a base of the recess.

10. The drilling template according to claim 1, wherein the drilling template is configured for use when producing rivet holes for connecting two fuselage sections of a fuselage for an aircraft or spacecraft in the region of a transverse seam on the fuselage.

11. A drilling template arrangement having at least two drilling templates, wherein a first drilling template comprises:
a first template part; and
a second template part′
wherein the first template part and the second template part are in each case provided with means for fixing positions of bores to be produced, and
wherein the first drilling template has coupling means, by which the first template part and the second template part can be coupled to one another in such a way that the coupled template parts are movable relative to one another, and
wherein a second drilling template engages over the first drilling template in regions.

12. The drilling template arrangement according to claim 11, wherein the second drilling template comprises:
a first template part; and
a second template part,
wherein the first template part and the second template part are in each case provided with means for fixing positions of bores to be produced, and
wherein the second drilling template has coupling means, by which the first template part and the second template part can be coupled to one another in such a way that the coupled template parts are movable relative to one another.

13. The drilling template arrangement according to claim 12, wherein one of the template parts of the second drilling template engages over the two template parts of the first drilling template in regions.

14. The drilling template arrangement according to claim 11, wherein the drilling template arrangement is configured for use when producing rivet holes for connecting two fuselage sections of a fuselage for an aircraft or spacecraft in the region of a transverse seam on the fuselage, the first drilling template being configured as an orbital template and the second drilling template being configured as a stringer template.

15. A method for introducing bores into at least two components for an aircraft or spacecraft, the method comprising:
providing at least one drilling template comprising a first template part, and a second template part, wherein the first template part and the second template part are in each case provided with means for fixing positions of bores to be produced, and wherein the drilling template has coupling means, by which the first template part and the second template part can be coupled to one another in such a way that the coupled template parts are movable relative to one another; and
installing the drilling template to produce the bores with the aid of the drilling template,
wherein manufacturing tolerances of one or both of the components are compensated by a movement of the first and second template parts relative to one another such that the positions of some of the bores to be produced can be aligned on one of the two components and the positions of other bores to be produced can be aligned on the other of the two components.

16. The method according to claim 15, wherein at least one further drilling template is provided, wherein the further drilling template is installed such that the further drilling template engages over the drilling template in regions.

17. The method according to claim 16, wherein the further drilling template comprising a first template part, and a second template part, wherein the first template part and the second template part are in each case provided with means for fixing positions of bores to be produced, and wherein the drilling template has coupling means, by which the first template part and the second template part can be coupled to one another in such a way that the coupled template parts are movable relative to one another, for the tolerance compensation between the components, one of the template parts of one of the drilling templates and one of the template parts of the other drilling template being aligned on the one component and the other template part of the one of the drilling templates and the other template part of the other of the drilling templates being aligned on the other component.

18. The method according to claim 15, wherein the bores are introduced into the component or the components by a semi-automatic drilling method.

19. The drilling template according to claim 2, wherein the first template part and the second template part are coupled to one another such that the drilling template having the first template part and the second template part can be transported as a whole in a non-installed state.

20. The method according to claim 18, wherein the bores are introduced into the component or the components by the concentric collet method.
